(19) United States
(12) Patent Application Publication
(10) Pub. No.: US 2004/0192314 A1
(43) Pub. Date: Sep. 30, 2004

(54) System, method and program product for estimating radio wave propagation characteristics

(75) Inventors: Yoshinori Watanabe, Tokyo (JP); Hiroto Sugahara, Tokyo (JP); Hiroshi Furukawa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/812,515

(22) Filed: Mar. 30, 2004

(30) Foreign Application Priority Data
Mar. 31, 2003 (JP) 2003-093188

(51) Int. Cl. H04Q 7/20

(52) U.S. Cl. 455/446; 455/424

(57) ABSTRACT

A radio wave propagation characteristics estimating system can estimate the propagation characteristics of a radio wave by ray tracing method that are suited for communication systems that occupy a large frequency band. The reflection coefficients, the diffraction coefficients and the transmission coefficients and the space attenuation ratio of the propagation course of each ray that arrives at reception point R1 are determined for each of a plurality of frequencies f1 to fM within the band occupied by the radio communication system that is the target of estimation to determine the intensity and the arrival delay time of the ray arriving at the reception point R1 for each of the frequencies f1 to fM. As a result, the frequency transfer functions for the frequencies f1 to fM are obtained. Then, the obtained frequency transfer functions are synthetically combined and the result of the synthesis is defined as radio wave propagation characteristic of the radio communication system between transmission point T1 and reception point R1.

### BACKGROUND OF THE INVENTION

1. Field of the Invention

This invention relates to a system, method and program product for estimating (predicting) the propagation characteristics of a radio wave. More particularly, the present invention relates to an improvement to a radio wave propagation characteristics estimation (prediction) system for determining the frequency transfer function of the radio wave by estimating the radio wave propagation characteristics on the basis of a ray tracing technique of tracing the courses of a plurality of the rays which approximate to the radio wave radiated from a transmission point and detecting the rays arriving at a reception point.

2. Description of the Related Art

The ultra wide band (UWB) communication method of emitting an ultra-short pulse wave from an antenna without modulation has been attracting attention as low cost and high speed radio communication technique at short distance because it does not require the use of an nonlinear circuit such as a mixer. In order to optimally design an ultra wide band communication system in terms of the pulse waveform, the antenna directivity, the transmission power and other factors, it is necessary to accurately grasp the actual radio wave propagation environment, or estimate (predict) the channel. The technique of radio wave propagation analysis using geometrical-optical approximation, or so-called ray tracing technique is generally employed to estimate the channel for short distance communications (See; S. Y. Seidel and T. S. Rappaport, “Site-Specific Propagation Prediction for Wireless In-Building Personal Communication System Design”, IEEE Trans VehTechnol, 43, 4, pp. 879-891, 1994).

With the ray tracing technique, radio wave propagation characteristics is estimated by decomposing the radio waves radiated from a transmission point into a plurality of rays, simulating the course of propagation of each ray by reflection, transmission and diffraction and detecting the ray arriving at each reception point (passing near each reception point). The radio wave radiated from the transmission point is a coherent wave. Appropriate values are selected respectively for the reflection coefficient, the transmission coefficient and the diffraction coefficient according to the set frequency (center frequency) of the coherent wave and the angle of incidence of the rays.

Now, the ray tracing technique will be described further by referring to FIGS. 9 to 11. FIG. 1 illustrates ray tracing when transmission point T1, reception point R1 and structures O1 to O3 are given in a predetermined observation area (observation space).

Referring to FIG. 1, ray Ra1 radiated from the transmission point T1 firstly strikes the structure O1. Then, reflected ray Ra2 and penetrated ray (transmitted ray) Ra3 are generated (produced) at reflection point Rf1 and propagated along respective directions. Electric power pr1 of the reflected ray Ra2 at the reflection point Rf1 can be calculated by multiplying the electric power of the ray Ra1 radiated at the transmission point T1 by the reflection coefficient and the space attenuation ratio through the propagation course from the transmission point T1 to the reflection point Rf1.

The reflected ray Ra2 then arrives at edge Rf2 of the structure O2 and diffracted by the edge Rf2 to generate (produce) diffracted ray Ra4. Electric power pr2 can be calculated by multiplying the electric power pr1 by the diffraction coefficient and the space attenuation ratio through the propagation course from the reflection point Rf1 to the edge Rf2.

The diffracted ray Ra4 then strikes the structure O3 to generate penetrated ray Ra6 and reflected ray Ra5. Electric power pr3 of the penetrated ray Ra6 at penetration point (transmission point) Rf3 can be calculated by multiplying the electric power pr2 by the penetration coefficient (transmission coefficient) and the space attenuation ratio through the propagation course from the edge Rf2 to the penetration point Rf3.

The penetrated ray Ra6 then arrives at the reception point R1. Electric power pr4 of the penetrated ray Ra6 that is received at the reception point R1 can be known by multiplying the electric power pr3 by the space attenuation ratio through the propagation course from the penetration point Rf3 to the reception point R1.

A delay profile as shown in FIG. 2 is recorded for the ray Ra6 that arrives at the reception point R1 on the basis of the reception intensity pr4 and the arrival delay time that is dependent on the total length of the propagation course from the transmission point T1 to the reception point R1.

In FIG. 2, horizontal axis 101 represents the arrival delay time that is required for the ray to radiate from the transmission point T1 and arrive to the reception point R1 and vertical axis 102 represents the reception intensity.

A delay profile as shown in FIG. 3 is eventually obtained as the arrival delay time and the reception intensity are recorded for each of all the rays that radiate from the transmission point T1 and arrive to the reception point R1 by way of respective courses that are different from each other. In FIG. 3, horizontal axis 111 represents the arrival delay time that is required for each of the rays to radiate from the transmission point T1 and arrive to the reception point R1 and vertical axis 112 represents the reception intensity.

While only the reception intensity of each of the rays that arrive at the reception point is recorded in the case of FIGS. 1 to 3, the phase rotation of the carrier may also be taken into consideration. When phase is taken into consideration, pr1 to pr4 of FIG. 1 represent not the electric powers but the amplitudes of electromagnetic field, each of which is expressed by a complex number. Then, each of the reflection coefficients, the transmission coefficients and the diffraction coefficients is expressed by a complex number.

With the ray tracing technique described above by referring to FIGS. 1 to 3, a complex impulse response at the reception point is obtained when phase is taken into consideration. Then, it is possible to obtain the frequency transfer function at the reception point by way of Fourier transform of the complex impulse response that is obtained at the reception point by taking phase into consideration. FIG. 4 shows the frequency transfer function that is obtained as a result of Fourier transform of the complex impulse response obtained at a reception point by the ray tracing technique. FIG. 4 shows infinitely expanding frequency characteristics that expand in both the positive direction and the negative direction starting from frequency f, when the frequency f of a coherent wave radiated from a transmission point is set as center of the expansion.

In above description of the ray tracing technique, the reflection coefficient, the transmission coefficient and the diffraction coefficient are set up on the basis of the set frequency (center frequency). However, the reflection coefficient, the transmission coefficient, the diffraction coefficient and the space attenuation ratio that are used for ray tracing are frequency dependent. Therefore, the frequency transfer function shown in FIG. 4 as an example becomes more unreliable as the difference between the observed frequency and the set frequency f of the coherent wave radiated from the transmission point increases. In other words, the ray tracing technique is not suitable for estimating the radio wave propagation characteristics of a communication system that occupies a large frequency bandwidth such as the UWB communication system.

### SUMMARY OF THE INVENTION

In view of the above-identified circumstances, it is therefore an object of the present invention to provide a system, method and computer program for estimating the propagation characteristics of a radio wave by ray tracing technique that is suited for communication systems that occupy a wide frequency band.

Another object of the present invention is to provide a system, method and computer program for estimating the propagation characteristics of a radio wave that can reduce the volume of computing operations necessary to estimate the radio wave propagation characteristics.

In an aspect of the present invention, the above object is achieved by providing a radio wave propagation characteristics estimating system for determining the frequency transfer function of the radio wave by estimating the radio wave propagation characteristics on the basis of a ray tracing technique of tracing the courses of a plurality of the rays which approximate to the radio wave radiated from a transmission point and detecting the rays arriving at a reception point, the system comprising:

first means for dividing the spectrum of a radio signal of a target radio communication system into a plurality of bands and determining the frequency transfer function of the predetermined frequency of each of the plurality of bands by the radio wave propagation characteristics estimation, the predetermined frequency of each of the plurality of bands being used as a frequency of the radio wave radiated from the transmission point; and

second means for estimating the radio wave propagation characteristics of the target radio communication system on the basis of the frequency transfer functions determined by the first means.

In another aspect of the invention, there is provided a radio wave propagation characteristics estimating method for determining the frequency transfer function of the radio wave by estimating the radio wave propagation characteristics on the basis of a ray tracing technique of tracing the courses of a plurality of the rays which approximate to the radio wave radiated from a transmission point and detecting the rays arriving at a reception point, the method comprising:

a first step for dividing the spectrum of a radio signal of a target radio communication system into a plurality of bands and determining the frequency transfer function of the predetermined frequency of each of the plurality of bands by the radio wave propagation characteristics estimation, the predetermined frequency of each of the plurality of bands being used as a frequency of the radio wave radiated from the transmission point; and

a second step for estimating the radio wave propagation characteristics of the target radio communication system on the basis of the frequency transfer functions determined by the first step.

In still another aspect of the invention, there is provided a program product embodied on a storage portion of a computer and comprising code that, when the program product is executed, cause the computer to perform a radio wave propagation characteristics estimating method, the method determining the frequency transfer function of the radio wave by estimating the radio wave propagation characteristics on the basis of a ray tracing technique of tracing the courses of a plurality of the rays which approximate to the radio wave radiated from a transmission point and detecting the rays arriving at a reception point, the method comprising:

a first step for dividing the spectrum of a radio signal of a target radio communication system into a plurality of bands and determining the frequency transfer function of the predetermined frequency of each of the plurality of bands by the radio wave propagation characteristics estimation, the predetermined frequency of each of the plurality of bands being used as a frequency of the radio wave radiated from the transmission point; and

a second step for estimating the radio wave propagation characteristics of the target radio communication system on the basis of the frequency transfer functions determined by the first step.

### BRIEF DESCRIPTION OF THE DRAWINGS

FIG. 1 is a schematic illustration of a conventional radio wave propagation characteristics estimating method;

FIG. 2 is a schematic illustration of delay profile at a reception point for a single ray;

FIG. 3 is a schematic illustration of delay profile at a reception point that is obtained by a conventional radio wave propagation characteristics estimating method;

FIG. 4 is a graph illustrating a frequency transfer function that is obtained by a conventional radio wave propagation characteristics estimating method;

FIG. 5 is a schematic illustration of an embodiment of radio wave propagation characteristics estimating method according to the present invention;

FIGS. 6A and 6B are graphs illustrating how frequency transfer functions are synthetically combined by the embodiment of radio wave propagation characteristics estimating method of FIG. 5;

FIG. 7 is a graph of illustrating the number M by which the frequency band is divided by the embodiment of FIG. 5;

FIG. 8 is a schematic block diagram of the functional blocks of an embodiment of radio wave propagation characteristics estimating system that uses the embodiment of radio wave propagation characteristics estimating method of FIG. 5;

FIG. 9 is a flow chart of operation of the embodiment of FIG. 8;

FIG. 10 is a schematic block diagram of a basic part of another embodiment of radio wave propagation characteristic estimating system that is realized by using a plurality of CPUs and a plurality of small capacity memories;

FIG. 11 is a schematic illustration of assigning a processing operation of tracing courses to the plurality of CPUs of the embodiment of FIG. 10; and

FIG. 12 is a schematic block diagram of another embodiment of radio wave propagation characteristics estimating system according to the present invention, showing the configuration thereof.

### DESCRIPTION OF THE PREFERRED EMBODIMENTS

In the best mode of carrying out the invention, the courses of a plurality of rays approximating those of the radio wave radiated from a transmission point are traced and the rays that arrive at a reception point are detected in order to predict the radio wave propagation characteristics between a transmission point and a reception point of a target radio communication system having a broad occupied bandwidth. Additionally, the occupied band of the target radio communication system is divided into M narrow bands (M represents a natural number above one) and each of the center frequencies f1 to fM of the M narrow bands is used as the frequency of the radio wave radiated from the transmission point.

Then, the reflection coefficient of each of the reflection points, the transmission coefficient of each of the transmission points, the diffraction coefficient of each of the diffraction points and the space attenuation ratio of the propagation course, on the propagation course of each of the rays that arrive at a reception point, are determined for each of the frequencies f1 to fM. As a result, it is possible to obtain the impulse response at the reception point for each of the frequencies f1 to fM radiated from the transmission point.

Then, frequency transfer functions are obtained by Fourier transform to impulse responses and synthetically combined on a frequency axis. The obtained result of composition (synthesis) is used as radio wave propagation characteristics between the transmission point and the reception point on the radio communication system.

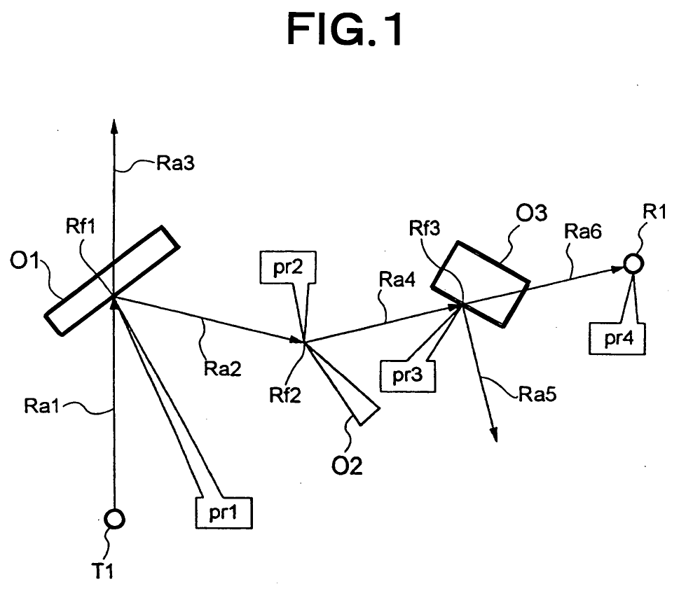

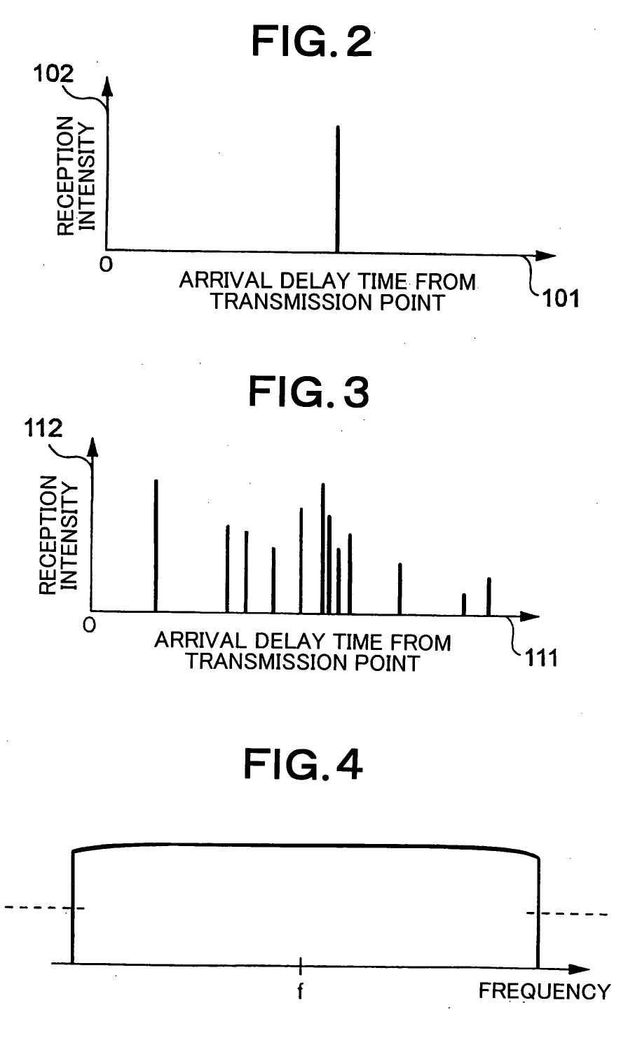

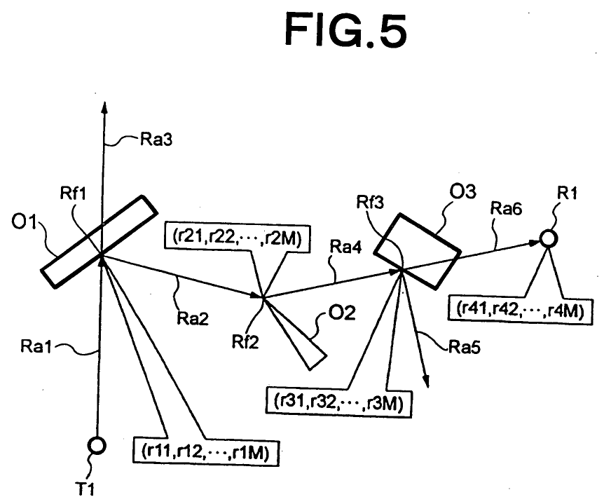

Now, the present invention will be described in greater detail by referring to the accompanying drawings that illustrate preferred embodiments of the invention. FIG. 5 is a schematic illustration of an embodiment of radio wave propagation characteristics estimating method (broad band channel estimating method) according to the invention. A situation same as that of FIG. 1 is assumed for FIG. 5. In other words, transmission point T1, reception point R1 and structures O1 to O3 are given in a predetermined observation area (observation space).

In this embodiment, the intensities of the reflected ray at the reflection point, the intensities of the diffracted ray at the diffraction point, the intensities of the penetrated ray at the penetration point and the intensities of the ray at the reception point are respectively given by complex intensities rij to reflect the reflection coefficient, diffraction coefficient, penetration coefficient and space attenuation ratio depending on frequency, where i represents the number of times of occurrences of reflections, penetration, diffractions and arrival from the transmission point T1 and j represents the frequency index of the radio wave radiated from the transmission point T1.

The range of the frequency index j is one to M (1≦j≦M), where M represents division number of the occupied band of target radio communication. The phase component of each of the complex intensities indicates the phase rotation of the carrier and the square of each of the complex intensities indicates the electric power of the ray.

Referring to FIG. 5, ray Ra1 radiated from the transmission point T1 firstly strikes the structure O1. Then, reflected ray Ra2 and penetrated ray Ra3 are produced at reflection point Rf1. The intensities of the reflected ray Ra2 at the reflection point Rf1 are given by (r11, r12, . . . , r1M) to reflect the reflection coefficient and space attenuation ratio depending on frequency.

The complex intensities r11 to r1M can be determined by determining the reflection coefficient at the reflection point Rf1 and the space attenuation ratio of the propagation course from the transmission point T1 to the reflection point Rf1 for each of the frequencies f1 to fM.

The ray Ra2 arrives at edge Rf2 of the structure O2 having edges and diffracted ray Ra4 is produced at the edge Rf2. The complex intensities of the diffracted ray Ra4 at the edge Rf2 are given by (r21, r22, . . . , r2M) to reflect the diffraction coefficient and space attenuation ratio depending on frequency. The complex intensities r21 to r2M can be determined by determining the diffraction coefficient at the edge Rf2 and the space attenuation ratio of the propagation course from the reflection point Rf1 to the edge Rf2 for each of the frequencies f1 to fM.

The ray Ra4 then strikes the structure O3 to produce penetrated ray (transmitted ray) Ra6 and reflected ray Ra5 at penetration point (transmission point) Rf3. The complex intensities of the penetrated ray Ra6 at the penetration point Rf3 are given by (r31, r32, . . . , r3M) to reflect the penetration coefficient (transmission coefficient) and space attenuation ratio depending on frequency. The complex intensities r31 to r3M can be determined by determining the penetration coefficient at the penetration point Rf3 and the space attenuation ratio of the propagation course from the edge Rf2 to the penetration point Rf3 for each of the frequencies f1 to fM.

The ray Ra6 then arrives at the reception point R1. The complex intensities of the ray Ra6 at the reception point R1 are given by (r41, r42, . . . , r4M) to reflect the space attenuation ratio depending on frequency. The complex intensities r41 to r4M can be determined by determining the space attenuation ratio of the propagation course from the penetration point Rf3 to the reception point R1 for each of the frequencies f1 to fM. The arrival delay time is determined on the basis of the total length of the propagation course from the transmission point T1 to the reception point R1 (the sum of the lengths of the propagation courses for the rays Ra1 to Ra6). When the frequency band for which the radio wave propagation characteristics are to be estimated can be found within a range where the electric characteristics of the materials of the structures can be regarded as uniform, the arrival delay time is same for all the frequencies. Therefore, the arrival delay time may be regarded as constant without problem for all the frequencies within a frequency band such as UWB that is used by communication equipment.

Thus, the complex intensity and the arrival delay time at the reception point R1 are determined for each of the frequencies f1 to fM, to the ray Ra6 that arrives and is detected at the reception point R1 by tracing the courses of the plurality of rays radiated from the transmission point T1. Therefore, the reception characteristics to the plurality of frequencies f1 to fM at the reception point R1 can be obtained by tracing the courses not M times but only once.

Similarly, the complex intensities and the arrival delay time at the reception point R1, to each of all the other rays that starts from the transmission point T1 and arrives at the reception point R1 by way of the different courses as detected by tracing the courses, are obtained for each of the frequencies f1 to fM. As a result, the complex impulse responses at the reception point R1 can be obtained for a radio wave having frequencies f1 to fM and radiated from the transmission point T1. Then, the frequency transfer functions of the radio wave having frequencies f1 to fM and radiated from the transmission point T1 are obtained by way of Fourier transform of each of the complex impulse responses (as a result of channel estimation).

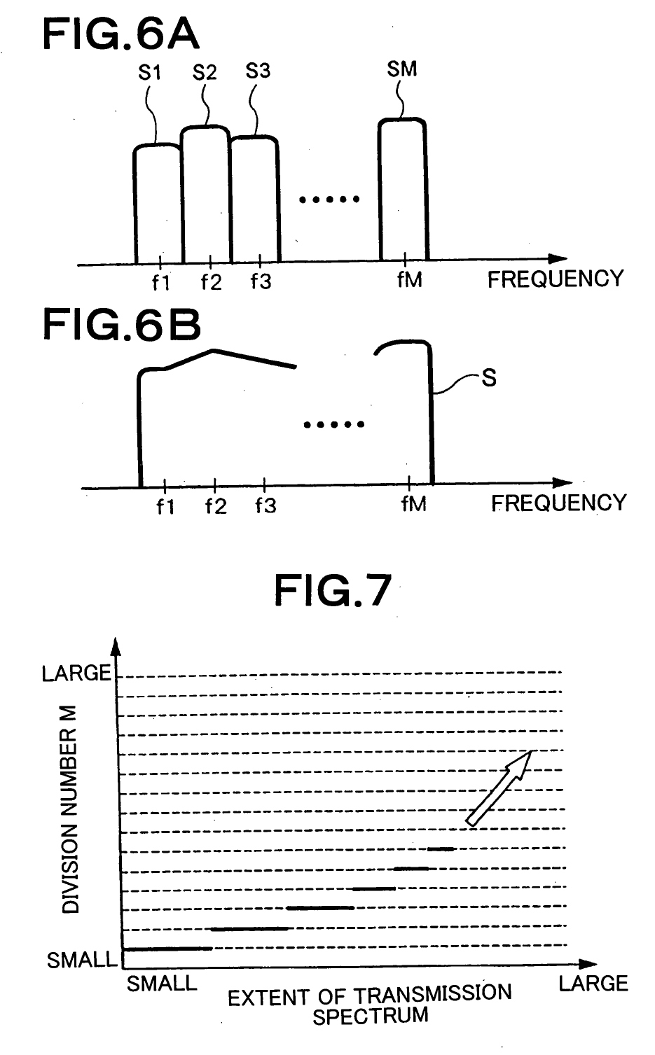

Then, the obtained frequency transfer functions are synthetically combined on a frequency axis. FIGS. 6A and 6B are graphs illustrating how frequency transfer functions are synthetically combined by a radio wave propagation characteristics estimating method according to the invention.

The frequency transfer functions are input to respective band pass filters for M bands whose center frequencies are f1 to fM respectively as described above. In other words, the frequency transfer function of the radio wave frequency f1 is input to the band pass filter that has a center frequency of f1. Thus, the frequency transfer function S1 is obtained as shown in FIG. 6A. Similarly, the frequency transfer functions of the radio wave frequencies f2 to fM are input respectively to the corresponding band pass filters so that the frequency transfer functions S2 to SM are obtained as shown in FIG. 6A.

Then, as shown in FIG. 6A, the frequency transfer functions S1 to SM are arranged on a frequency axis. The frequency transfer functions S1 to SM are smoothed and synthetically combined as shown in FIG. 6B. As a result, the frequency transfer function S is obtained as radio wave propagation characteristic between the transmission point T1 and the reception point R1 on the target radio communication system (as a result of broad band channel estimation).

Note that while the frequencies f1 to fM are arranged at regular intervals in FIGS. 6A and 6B, they may be arranged at irregular intervals.

As described above, with the embodiment of the present invention, it is possible to perform an operation of broad band channel estimation by means of a ray tracing technique, where a plurality of frequency transfer functions S1 to SM (obtained as a result of a plurality of narrow band channel estimations) are synthetically combined. It is also possible to reduce the volume of computing operations necessary to estimate the radio wave propagation characteristics because the reception characteristics of a plurality of frequencies can be obtained by a single operation of tracing the propagation courses of rays.

The accuracy of broad band channel estimation using M frequency bands obtained by dividing the frequency spectrum of a radio signal according to the invention will be raised by increasing the value of M. However, both the storage capacity of the memory and the volume of computing operations necessary for channel estimation increase as the value of M increases. FIG. 7 is a graph illustrating the number M by which the frequency band is divided by the embodiment of FIG. 5. FIG. 7 shows that the lower limit frequency and the upper limit frequency are defined for the spectrum of the transmitted signal of the target radio communication system and how the spectrum between the lower limit frequency and the upper limit frequency is divided into a number of bands.

Referring to FIG. 7, the division number M increases as the spectrum of the transmitted signal is broadened. The extent of the spectrum of the transmitted signal is the bandwidth between the lower limit frequency and the upper limit frequency (the bandwidth of the spectrum of the transmitted signal), the bandwidth between the lower limit frequency and the upper limit frequency, which the frequency that provides the largest electric power is centered and the electric power of each of the lower and upper limit frequencies is attenuated from the power of the center frequency by XdB (the bandwidth of the spectrum of radio signal having power over the power smaller than the largest power of the spectrum. by a predetermined value), or band dispersion of the spectrum of the transmitted signal. The band distribution SP of the spectrum of the transmitted signal is defined by formula (1) below when the frequency spectrum of the transmitted signal is given as Ts(f),

$$SP = \frac{{\int }_{- ∞}^{∞} {( f - {f}_{A} )}^{2} {Ts}^{2} ( f ) ⅆ f}{{\int }_{- ∞}^{∞} {Ts}^{2} ( f ) ⅆ f} , \qquad ( 1 )$$

where f_{A} is the energy center frequency that is defined by formula (2) below,

$${f}_{A} = \frac{{\int }_{- ∞}^{∞} {fTs}^{2} ( f ) ⅆ f}{{\int }_{- ∞}^{∞} {Ts}^{2} ( f ) ⅆ f} . \qquad ( 2 )$$

Thus, the division number M is selected according to the extent of the spectrum of the transmitted signal and consequently, the suitable division number is selected according to the bandwidth occupied by the transmitted signal. Therefore, the efficiency of channel estimation is raised.

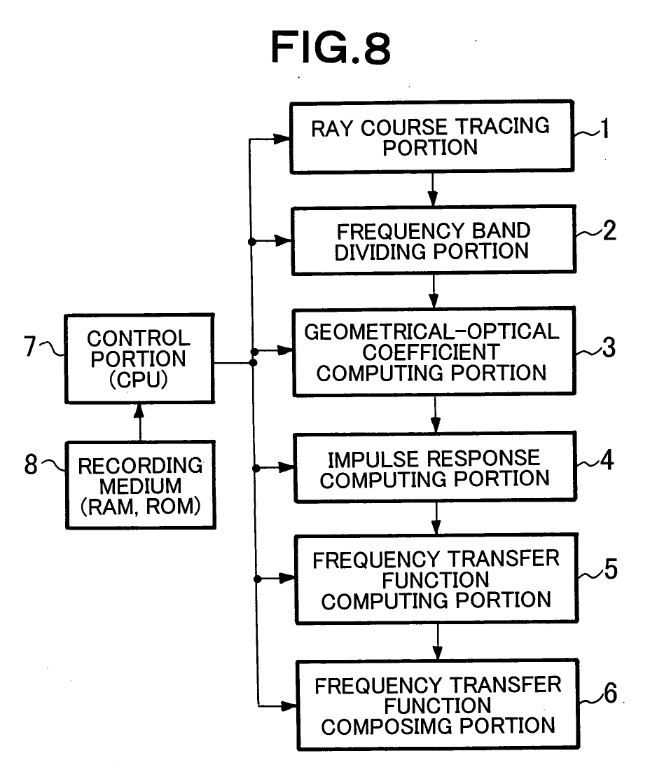

FIG. 8 is a schematic block diagram of the functional blocks of an embodiment of radio wave propagation characteristics estimating system that uses the above described embodiment of radio wave propagation characteristics estimating method.

Referring to FIG. 8, ray course tracing portion 1 is a functional block that traces the propagation course of each ray between the transmission point and the reception point, which is driven to operate only once regardless of the division number M for dividing the frequency band of the transmitted signal. Frequency band dividing portion 2 is a functional block that divides the frequency band optimally according to the extent of the frequency spectrum of the transmitted signal. Geometrical-optical coefficient computing portion 3 is a functional block that computes the reflection coefficient, the transmission coefficient and the diffraction coefficient for each of the center frequencies f1 to fM of the M bands obtained by dividing the frequency spectrum respectively for the reflections, the transmissions and the diffractions that occur to each ray on the propagation course of the signal before arriving at the reception point as detected by the ray course tracing portion 1.

Impulse response computing portion 4 is a functional block that computationally determines the impulse response of each of the M divided frequency bands at the reception point. Frequency transfer function computing portion 5 is a functional block that performs a Fourier transform operation on each impulse response as determined by the impulse response computing portion 4 and obtains by computations the frequency transfer functions. Frequency transfer function composing (synthesizing) portion 6 is a functional block that obtains the frequency transfer function as radio wave propagation characteristic between the transmission point and the reception point of the target radio communication system by filtering the frequency transfer functions of the divided bands obtained by the frequency transfer function computing portion 5 by means of band pass filters, whose pass bands respectively correspond to bandwidth of the divided bands respectively, and arranging them on a frequency axis.

Control portion 7 controls the portions 1 to 6 according to the processing sequence of the computer program stored in recording medium 8. A CPU contains the control portion 7 and operation portion. The operation of the portions 1 to 6 are carried out on the operation portion. The recording medium (storage portion) 8 comprises a Random Access Memory (RAM) and a Read Only Memory (ROM), of which the RAM is an scratchpad memory of the CPU, while the ROM stores computer programs. The processing sequence can be controlled as it is stored in the ROM as program in advance.

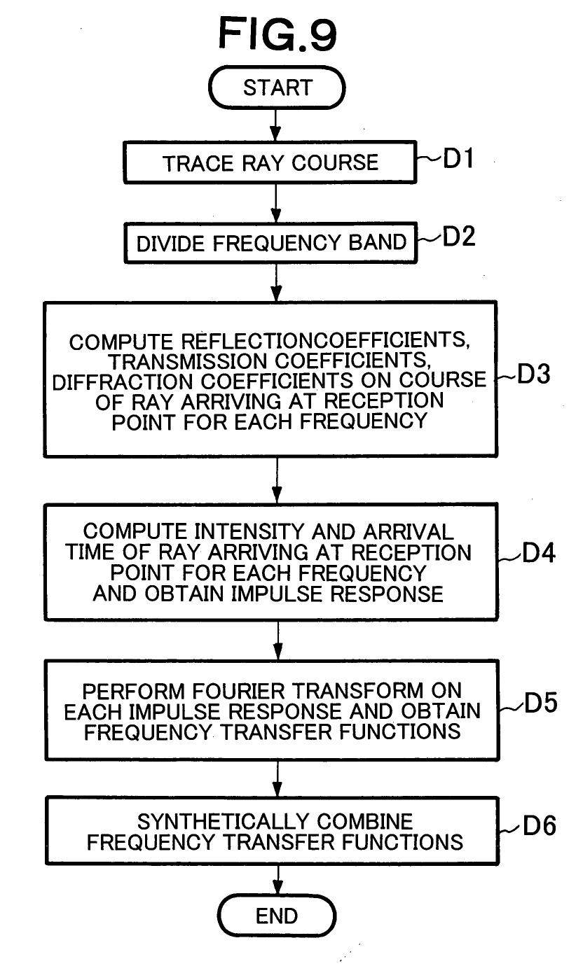

FIG. 9 is a flow chart of operation of the embodiment of FIG. 8. As shown from 5, the operation sequence agrees with the order of arrangement of the functional blocks of FIG. 8. In other words, Steps D1 to D6 in FIG. 9 correspond respectively to the processing operations of the portions 1 to 6. The operation of dividing the band in Step D2 may be performed prior to the operation of tracing the ray course in Step D1.

In the embodiment, the computing operations for tracing the ray courses by means of the ray tracing technique generally provide a heavy load and may take a long time particularly when the propagation environment is complex (complicated). Additionally, if reception points other than the reception point R1 are given in the predetermined area, the computing operations of the frequency transfer function computing portion 5 of FIG. 8 for Fourier transform also provide a heavy load and may take a long time. Furthermore, if time resolution to impulse response is increased, the memory capacity of the memory for storing the arrival delay times of the delayed pulses that arrive at the reception point and their reception intensities may have to be consumed to a large extent. Consumption of memory capacity may further increase when the total number of reception points is large, so that a costly large capacity memory may have to be installed.

While the above-described embodiment may be realized by using a single CPU and a single memory (for example, as a computer), it is highly effective to arrange a plurality of CPUs for the purpose of parallel processing and distribute consumption of memory capacity among a plurality of small capacity memories in order to accurately analyze the complicated propagation environment and, at the same time, avoid consumption of the memory capacity of the costly memory.

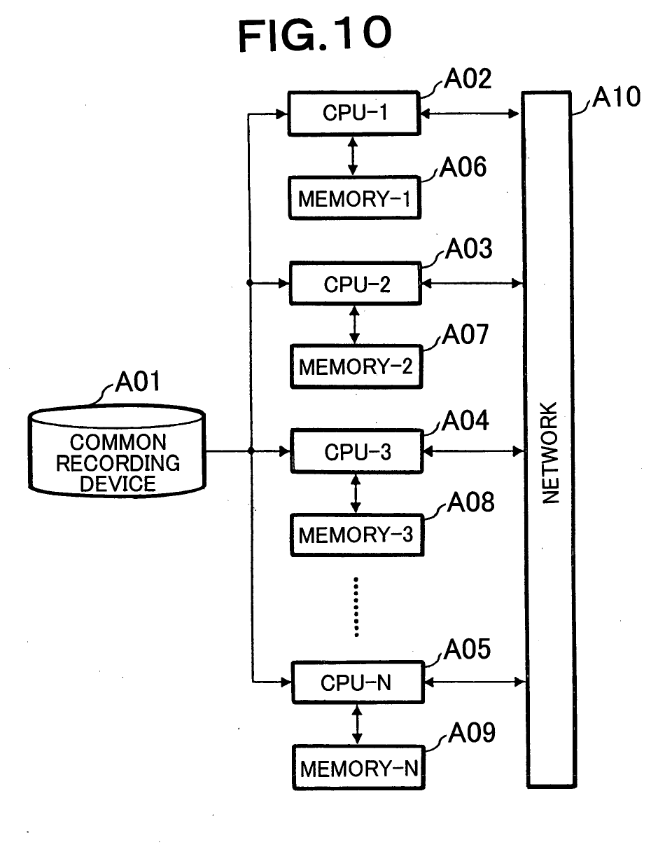

FIG. 10 is a schematic block diagram of an embodiment of radio wave propagation characteristic estimating system according to the invention that is realized by using a plurality of CPUs and a plurality of small capacity memories. The system illustrated in FIG. 10 comprises N (N represents natural number more than 1; namely, N≧2) central processing units (CPUs 1 to N) A02 to A05, N memories (memories 1 to N) A06 to A09, common recording device A01 and network A10 and each of the CPU can communicate with all the other CPUs by way of the network A10. All the CPUs 1 to N can access to the common recording device A01 to write and read data.

The common recording device A01 may be connected with one of the CPUs 1 to N, for example, as a personal computer (PC) containing one of the CPUs 1 to N and the common recording device A01. In the case, all the other CPUs access to the common recording device A01 though the network A10. The common recording device A01 may be arranged on the network A10. Further, the common recording device A01 may be connected with CPU other than CPUs 1 to N, for example, as PC containing the CPU and the common recording device A01. The common recording device A01 is used to record frequency transfer functions and store operation programs for controlling the CPUs.

The propagation courses of rays between a transmission point and a reception point can be divided into a plurality of directions which start from transmission point (a plurality of directions to which the rays are radiated respectively) without any mutual overlaps. Therefore, each of the processes Step D1 to D4 in FIG. 9 can be carried out in parallel by assigning the calculation about the plurality of directions that start from the transmission point to the CPUs every direction.

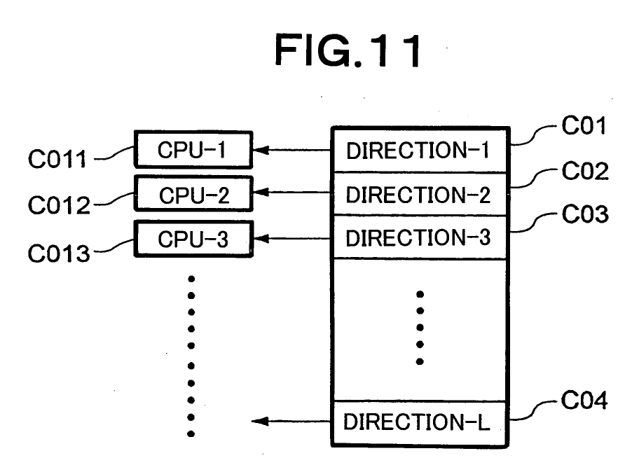

FIG. 11 is a schematic illustration of assigning a processing operation of tracing propagation courses (processing operation of Step D1) to the plurality of CPUs. FIG. 11 shows how ray-course tracing process data C01 to C04 that are data of ray-course tracing processes about directions 1 to L are assigned to a plurality of CPUs C11 to C13 (CPUs 1 to N). The ray-course tracing process data C01 to C04 are held in memories 1 to N (N=L) in FIG. 10, respectively. With this parallel process, the processing operation of tracing the courses can be carried out in a short period of time.

With this technique, the ray course tracing portion 1 (see FIG. 8) of each of the CPUs 1 to N is carried out to trace the courses of the rays that are radiated to the assigned direction and arrive to a plurality of reception points. When a ray arriving at each of the reception points is detected, the geometrical-optical coefficient computing portion 3 (see FIG. 8) of each of the CPUs 1 to N computationally determines the reflection coefficients, the transmission coefficients and the diffraction coefficients on the propagation course of each of the rays for each of the center frequencies f1 to fM of the M bands that are produced by the frequency band dividing portion 2.

The impulse response computing portion 4 (see FIG. 8) of each of the CPUs 1 to N computationally determines the impulse response of each of the M divided frequency bands at each of the reception points by determining the arrival delay time and the intensity of the ray for each of the frequencies f1 to fM. A partial impulse response (a impulse response for one direction) is obtained from the arrival delay time and the intensity of the ray. Therefore, the overall impulse response (impulse response for all directions 1 to L) at each reception point is obtained by synthetically combining the partial impulse responses obtained by the impulse response computing portions 4 of the CPUs 1 to N. The processes until determining the partial impulse response can be carried out in parallel by the CPUs 1 to N.

The partial impulse response for all reception points stored in the memory to each CPU can be assembled to one of the memories 1 to N (for example, memory 1) through the network A10. However, in this case, the memory (one of the memories 1 to N) needs to have a large memory capacity. The consumption of memory capacity can be distributed when a memory assembling the partial impulse responses is used for each of the reception points. For example, when the reception points is two points, memory 1 and 2 are used for the two reception points, respectively. Then, the impulse response computing portion 4 of the CPU accompanying by the memory assembling the partial impulse responses at a reception point determines the impulse response for the frequencies f1 to fM by synthetically combining the partial impulse responses for the frequencies f1 to fM.

Additionally, in the CPU accompanying by the memory assembling the partial impulse responses at a reception point, the frequency transfer function computing portion 5 (see FIG. 8) determines the frequency transfer functions by Fourier transform of the impulse responses for the frequencies f1 to fM and the frequency transfer function composing (synthesizing) portion 6 (see FIG. 8) synthetically combines the obtained frequency transfer functions. With this arrangement, a CPU accompanying by the memory assembling the partial impulse responses at a reception point computationally determines the frequency transfer functions at the reception point, so that the load of computationally determining and synthetically combining the frequency transfer functions of the reception points can be distributed without difficulty. The CPUs other than the CPU accompanying by the memory assembling the partial impulse responses at a reception point may not necessarily comprise the frequency transfer function computing portion 5 and the frequency transfer function synthesizing portion 6.

Finally, the transfer function obtained by synthesis of the CPU accompanying by the memory assembling the partial impulse responses at a reception point is recorded in the common recording device A01, which may typically be a hard disk. Therefore, the analysis of the radio wave propagation characteristics between the transmission point and each of the reception points can be carried out by using a small capacity memory.

With the above-described method, the load of computations and the consumption of memory capacity can be distributed respectively by using a plurality of CPUs and a plurality of small capacity memories that are less costly. Therefore, the analysis of the radio wave propagation characteristics can be carried out at high speed and at low cost.

The above-described method is realized by a processing operation including Steps D1 to D4 as shown in FIG. 9 on the ray assigned to each of the plurality of CPUs 1 to N and Steps D5 and D6 as shown in FIG. 9 that are performed by one or more CPUs (one or more CPUs of CPUs 1 to N) accompanying by one or more memories which assemble the partial impulse responses at reception points respectively.

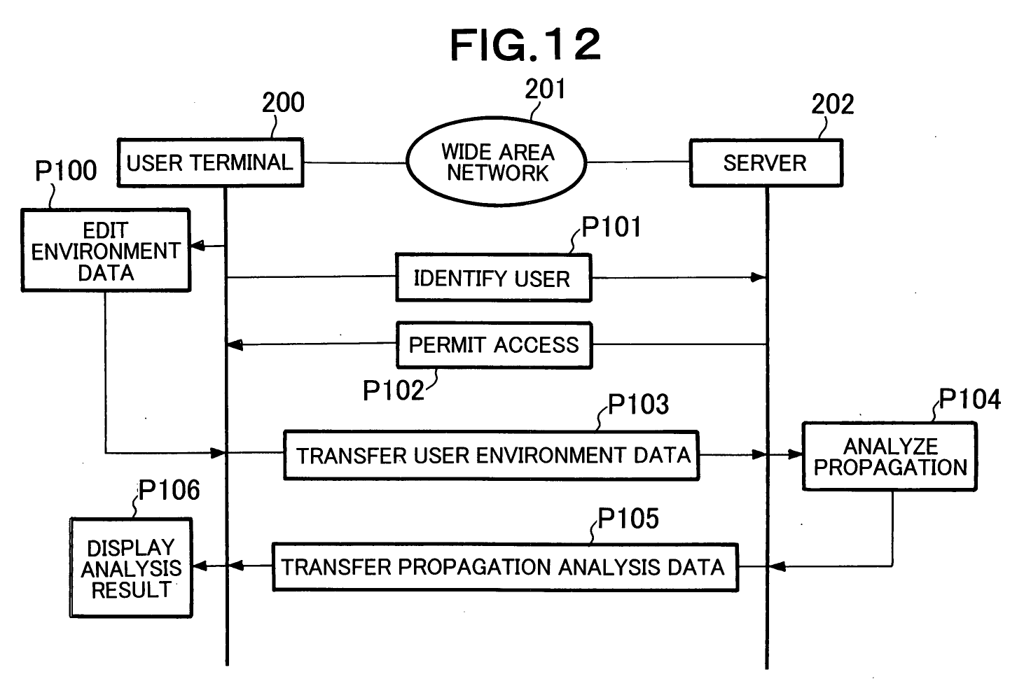

A radio wave propagation analyzing system according to the above-described embodiment may be realized by a stand-alone type computer. However, the cost of configuring a system can be highly costly when each user configures it by himself or herself. FIG. 12 is a schematic block diagram of an embodiment, or a model, of radio wave propagation characteristics estimating system according to the invention, where the radio wave propagation analyzing part is shared by a plurality of users through the network. In this model, each user terminal 200 accesses server 202 through wide area network 201. The server 202 has a user identification function and a radio wave propagation analyzing function. A radio wave propagation analyzing system using a single CPU or a plurality of CPUs as described above is included in the server 202.

Referring to FIG. 12, the user firstly edits environment data, using editing client (program) stored in the user terminal (P100). The environment data include structure information on the space to be analyzed and the server 202, which operates as radio wave propagation analysis simulator, traces rays on the basis of the structure information. The environment data may include information on the characteristics of the specifications of the radio communication system to be analyzed, so that the user can give the server 202 instructions for the radio wave propagation analysis that can take the characteristics of the radio communication system into consideration, such as the method for frequency division on the radio communication system.

Then, the server 202 identifies the user whether the user can transfer the edited environment data to the server or not (P101) and, if appropriate, gives the user permission to access (P102). The data that are exchanged between the server 202 and the user terminal 200 are held confidential by the access control using the identification system and encoding the related communication paths so that any of the environment data and the analysis data do not leak to a third party without permission on the part of the user.

After the identification process, the user transfers the environment data to the server 202 (P103) and the server 202 performs an operation of radio wave propagation analysis on the basis of the received environment data (P104). When the analysis operation is over, the server transfers the result of the analysis to the user (P105) and the user terminal 200 displays the result of the analysis (P106).

As described above, with this technique, costly components of the system for propagation analysis such as propagation analysis simulator can be shared to reduce the cost of analysis. Additionally, a core part of the system can be controlled centrally to facilitate maintenance.

Thus, according to each of the embodiments, the radio wave propagation characteristics between a transmission point and a reception point of a target radio communication system having a broad occupied bandwidth are estimated by repeatedly carrying out an operation of estimating the radio wave propagation characteristics of a radio wave radiated from a transmission point for a plurality of times, while varying the frequency of the radio wave within the occupied band of the radio communication system. Then, the frequency transfer functions are synthetically combined on a frequency axis and the obtained result of synthesis is used as radio wave propagation characteristics of the radio communication system between the transmission point and the reception point.

Additionally, according to each of the embodiments, the operation of searching for the course of propagation of rays is carried out only once because the course of propagation is identical for different rays radiated from a transmission point regardless of radio wave frequency. Then, frequency transfer functions are determined by selecting appropriate values for the reflection coefficient, the transmission coefficient, the diffraction coefficient and the space attenuation ratio for each ray arriving at the reception point detected by the single searching operation without repeating the same searching operation for a plurality of times.

Additionally, according to each of the embodiments, it is possible to estimate (predict) the propagation characteristics of a radio wave by ray tracing method that are suited for communication systems that occupy a large frequency band.

Additionally, according to each of the embodiments, the propagation loss of each of the rays that arrives at the reception point as detected by tracing their courses is checked for each of the frequencies of the ray, so that the radio wave propagation characteristics of the radio communication system can be estimated without repeatedly carrying out the course tracing operation. Thus, the volume of computations necessary for estimating the radio wave propagation characteristics is reduced and the operation of estimating the radio wave propagation characteristics is performed at high speed.

What is claimed is:

1. A radio wave propagation characteristics estimating system for determining the frequency transfer function of the radio wave by estimating the radio wave propagation characteristics on the basis of a ray tracing technique of tracing the courses of a plurality of the rays which approximate to the radio wave radiated from a transmission point and detecting the rays arriving at a reception point, said system comprising:
first means for dividing the spectrum of a radio signal of a target radio communication system into a plurality of bands and determining the frequency transfer function of a predetermined frequency of each of said plurality of bands by said radio wave propagation characteristics estimation, said predetermined frequency of each of said plurality of bands being used as a frequency of the radio wave radiated from said transmission point; and
second means for estimating the radio wave propagation characteristics of said target radio communication system on the basis of the frequency transfer functions determined by said first means.

2. The system according to claim 1, wherein said second means estimates said radio wave propagation characteristics by filtering the frequency transfer functions determined by said first means with band pass filters having pass bands respectively corresponding to the plurality of bands obtained by dividing the spectrum, and arranging and synthetically combining the filtered frequency transfer functions on a frequency axis.

3. The system according to claim 1, wherein said first means comprises third means for acquiring information on the arrival delay time and intensity of each of the rays arriving at said reception point for each of said predetermined frequencies by estimating said radio wave propagation characteristics and determines the frequency transfer function for each of said predetermined frequencies on the basis of the information acquired by said third means.

4. The system according to claim 3, wherein said third means acquires information for each of said predetermined frequencies by tracing the courses of said plurality of rays only once.

5. The system according to claim 3, wherein said third means is provided for each of a plurality of directions to which the rays are radiated from the transmission point so as to carry out in parallel.

6. The system according to claim 1, wherein the number of a plurality of said predetermined frequencies is set on the basis of the extent of said spectrum of radio signal.

7. The system according to claim 6, wherein the extent of said spectrum of radio signal is the bandwidth of said spectrum of radio signal.

8. The system according to claim 6, wherein the extent of said spectrum of radio signal is the band distribution of said spectrum of radio signal.

9. The system according to claim 6, wherein the extent of said spectrum of radio signal is the bandwidth of said spectrum of radio signal having power over the power smaller than the largest power of the spectrum by a predetermined value.

10. A radio wave propagation characteristics estimating method for determining the frequency transfer function of the radio wave by estimating the radio wave propagation characteristics on the basis of a ray tracing technique of tracing the courses of a plurality of the rays which approximate to the radio wave radiated from a transmission point and detecting the rays arriving at a reception point, said method comprising:
a first step for dividing the spectrum of a radio signal of a target radio communication system into a plurality of bands and determining the frequency transfer function of a predetermined frequency of each of said plurality of bands by said radio wave propagation characteristics estimation, said predetermined frequency of each of said plurality of bands being used as a frequency of the radio wave radiated from said transmission point; and
a second step for estimating the radio wave propagation characteristics of said target radio communication system on the basis of the frequency transfer functions determined by said first step.

11. The method according to claim 10, wherein said radio wave propagation characteristics are estimated in said second step by filtering the frequency transfer functions determined in said first step with band pass filters having pass bands respectively corresponding to the plurality of bands obtained by dividing the spectrum, and arranging and synthetically combining the filtered frequency transfer functions on a frequency axis.

12. The method according to claim 10, wherein said first step comprises a third step of acquiring information on the arrival delay time and intensity of each of the rays arriving at said reception point for each of said predetermined frequencies by estimating said radio wave propagation characteristics, and the frequency transfer function for each of said predetermined frequencies on the basis of the information acquired in said third step is determined in said first step.

13. The method according to claim 12, wherein said information is acquired for each of said predetermined frequencies by tracing the courses of said plurality of rays only once in said third step.

14. The method according to claim 12, wherein said third step is provided for each of a plurality of directions to which the rays are radiated from the transmission point so as to carry out in parallel.

15. The method according to claim 10, wherein the number of a plurality of said predetermined frequencies is set on the basis of the extent of said spectrum of radio signal.

16. The method according to claim 15, wherein the extent of said spectrum of radio signal is the bandwidth of said spectrum of radio signal.

17. The method according to claim 15, wherein the extent of said spectrum of radio signal is the band distribution of said spectrum of radio signal.

18. The method according to claim 15, wherein the extent of said spectrum of radio signal is the bandwidth of said spectrum of radio signal having power over the power smaller than the largest power of the spectrum by a predetermined value.

19. A program product embodied on a storage portion of a computer and comprising code that, when said program product is executed, cause said computer to perform a radio wave propagation characteristics estimating method, said method determining the frequency transfer function of the radio wave by estimating the radio wave propagation characteristics on the basis of a ray tracing technique of tracing the courses of a plurality of the rays which approximate to the radio wave radiated from a transmission point and detecting the rays arriving at a reception point, said method comprising:
a first step for dividing the spectrum of a radio signal of a target radio communication system into a plurality of bands and determining the frequency transfer function of a predetermined frequency of each of said plurality of bands by said radio wave propagation characteristics estimation, said predetermined frequency of each of said plurality of bands being used as a frequency of the radio wave radiated from said transmission point; and
a second step for estimating the radio wave propagation characteristics of said target radio communication system on the basis of the frequency transfer functions determined by said first step.
